(19) United States
(12) Patent Application Publication
(10) Pub. No.: US 2024/0185742 A1
(43) Pub. Date: Jun. 6, 2024

(54) LINERLESS LABEL WITH REDUCED ADHESIVE

(71) Applicant: Chicago Tag & Label, Inc., Libertyville, IL (US)

(72) Inventors: F. Paul Valenti, JR., Barington, IL (US); Carl Opel, Carol Stream, IL (US); Daniel Hedger, Grayslake, IL (US)

(21) Appl. No.: 18/524,123

(22) Filed: Nov. 30, 2023

Related U.S. Application Data
(60) Provisional application No. 63/429,734, filed on Dec. 2, 2022.

(51) Int. Cl. G09F 3/02

(52) U.S. Cl. CPC G09F 3/02; G09F 2003/023

(57) ABSTRACT

A linerless label having plurality of alternating parallel adhesive stripes and parallel adhesive voids that cover substantially the full surface of one side of the linerless label.

### RELATED APPLICATION

This application claims the benefit of U.S. Provisional Application No. 63/429,734, filed on Dec. 2, 2022. The disclosure of this prior application is incorporated herein by reference in its entirety for all purposes.

### BACKGROUND

Printing occurs in a thermal printer when the substrate, such as a label, is driven underneath a thermal printhead, which is a fixed non-moving part. The substrate is driven under and through the printhead by a platen roller, which also serves as the back-up/impression roller in the printer. Pressure is established between the printhead and the platen roller to cause the printed image to appear on the substrate.

Label users have an interest in reducing the amount of material used and wasted in the process of manufacturing, applying, and using labels, while retaining reliable performance of the label. One way to reduce the amount of material is to use a linerless label, so the liner is completely eliminated. Printing of linerless labels with a thermal printer is more difficult and more delicate than printing typical labels on a carrier liner, because the exposed adhesive on the back of the linerless label must come into contact with the platen roller of the printer while the thermal printhead is in contact with the top side of the label while printing on it. Platen rollers in thermal printers have non-stick surfaces, typically a non-stick coating. However, over time the non-stick characteristic of the platen roller deteriorates due to wear, and labels can stick to the roller while printing and thereby cause printer jams.

For the foregoing reasons it is desired to provide a linerless label that uses less adhesive, while retaining reliable performance of the label. By reducing the amount of adhesive introduced into the printing equipment, one could extend the life of the printing equipment and lengthen the maintenance interval on the printing equipment.

### SUMMARY

The present disclosure includes disclosure of a linerless label with reduced adhesive comprises angled adhesive stripes and corresponding adhesive void stripes that alternate. The adhesive pattern contains void stripes to reduce adhesive usage, while providing approximately 50% coverage of adhesive on all latitudinal positions along the length of the label, and an equally distributed amount of adhesive longitudinally across the width of the label, while providing adhesion performance equivalent to that of a full adhesive label.

In at least one embodiment, a linerless label according to the present disclosure comprises a label material, the label material comprising a first side and an opposing second side, the first side and the second side being bounded by a leading edge, a trailing edge, a first side edge, and a second side edge; and an adhesive on the second side of the label material, the adhesive configured in a plurality of parallel adhesive stripes oriented in a manner that is neither parallel to nor perpendicular to any of the leading edge, the trailing edge, the first side edge, or the second side edge, wherein all of the adhesive stripes are of substantially equal width, and where each adhesive stripe is spaced apart from its neighboring adhesive stripe by an adhesive void that is of a substantially equal width to the adhesive stripes.

In at least one embodiment of a linerless label according to the present disclosure, an angle formed by the first side edge and the adhesive stripes is between about 20 degrees and 45 degrees. In at least one embodiment of a linerless label according to the present disclosure, an angle formed by the first side edge and the adhesive stripes is between about 30 degrees and 40 degrees. In at least one embodiment of a linerless label according to the present disclosure, an angle formed by the first side edge and the adhesive stripes is between about 35 degrees and 40 degrees. In at least one embodiment of a linerless label according to the present disclosure, an angle formed by the first side edge and the adhesive stripes is about 30 degrees.

In at least one embodiment of a linerless label according to the present disclosure, a combined width of one adhesive stripe and one adjacent adhesive void is about 0.25 inches. In at least one embodiment of a linerless label according to the present disclosure, each adhesive stripe is about 0.125 inches wide and each adhesive void is about 0.125 inches wide. In at least one embodiment of a linerless label according to the present disclosure, each adhesive stripe is between about 0.125 inches wide and 0.15 inches wide and each adhesive void is between about 0.1 inches wide and 0.125 inches wide.

In at least one embodiment, a linerless label according to the present disclosure comprises a label material, the label material comprising a first side and an opposing second side, the first side and the second side being bounded by a leading edge, a trailing edge, a first side edge, and a second side edge; and an adhesive on the second side of the label material, the adhesive configured in a plurality of parallel adhesive stripes oriented in a manner that is neither parallel to nor perpendicular to any of the leading edge, the trailing edge, the first side edge, or the second side edge, wherein all of the adhesive stripes are of substantially equal width, and where each the adhesive stripe is spaced apart from its neighboring adhesive stripe by an adhesive void, wherein all of the adhesive voids are of substantially equal width.

### BRIEF DESCRIPTION OF THE DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 shows a linerless label according to at least one embodiment of the present disclosure;

FIG. 2 shows a linerless label according to at least one embodiment of the present disclosure; and

FIG. 3 shows a linerless label according to at least one embodiment of the present disclosure being processed by a thermal printer.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

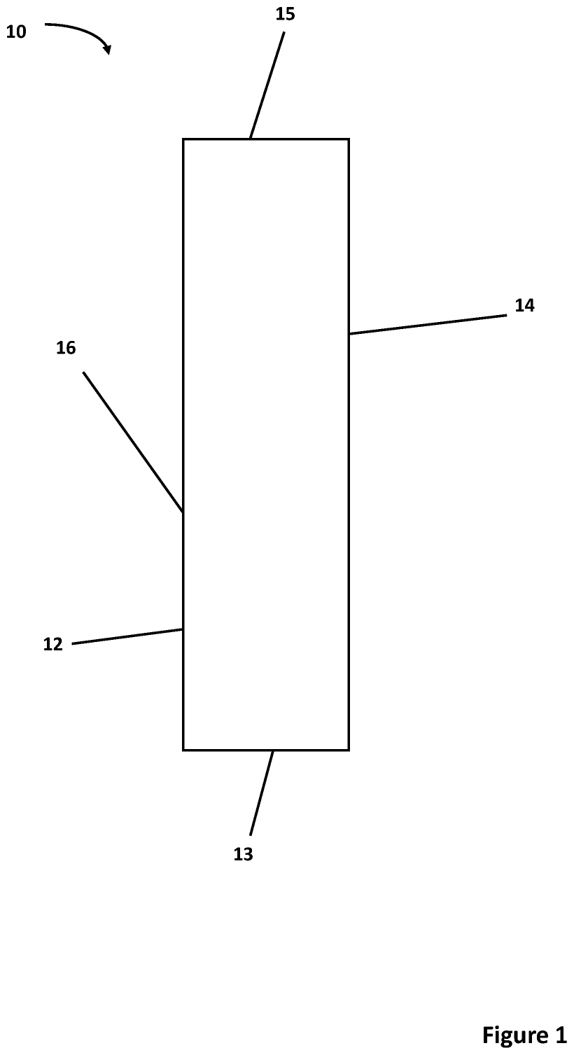

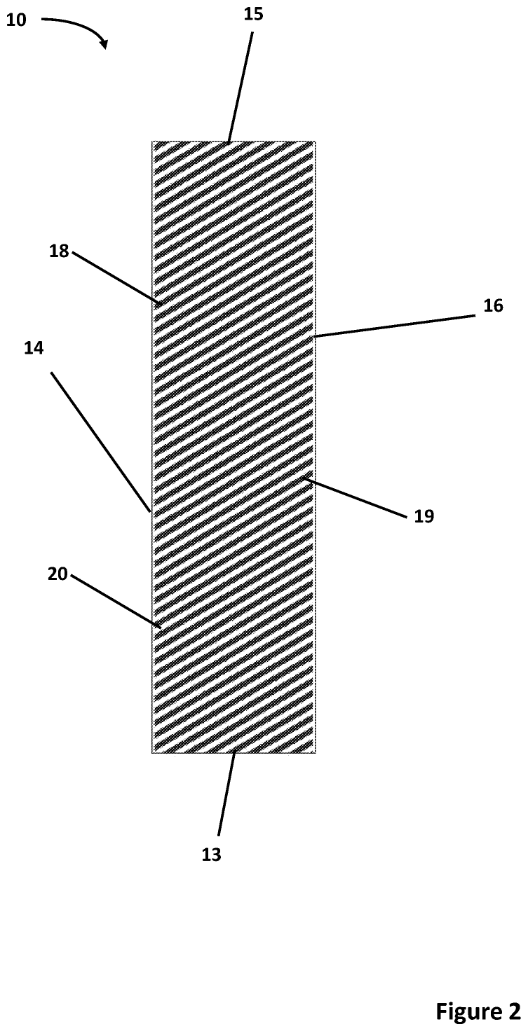

FIGS. 1-2 show a linerless label 10, according to at least one embodiment of the present disclosure. As shown in FIGS. 1-2, linerless label 10 according to this embodiment comprises a sheet material having first side 12 and opposing second side 18. Linerless label 10 is bounded by leading edge 13, trailing edge 15, first side edge 14, and second side edge 16. In at least one embodiment, linerless label 10 comprises a material such as, for example, paper, that is both suitable for the printing of indicia on first side 12 and suitable for receiving adhesive on second side 18, without coating or other treatments.

As is best seen in FIG. 2, linerless label 10 comprises an adhesive pattern on second side 18. The adhesive pattern comprises a plurality of alternating adhesive stripes 19 and adhesive voids 20 that cover substantially the full surface of second side 18 of linerless label 10. In at least one embodiment of linerless label 10, adhesive stripes 19 and adhesive voids 20 are of equal width, resulting in adhesive covering approximately 50% of second side 18.

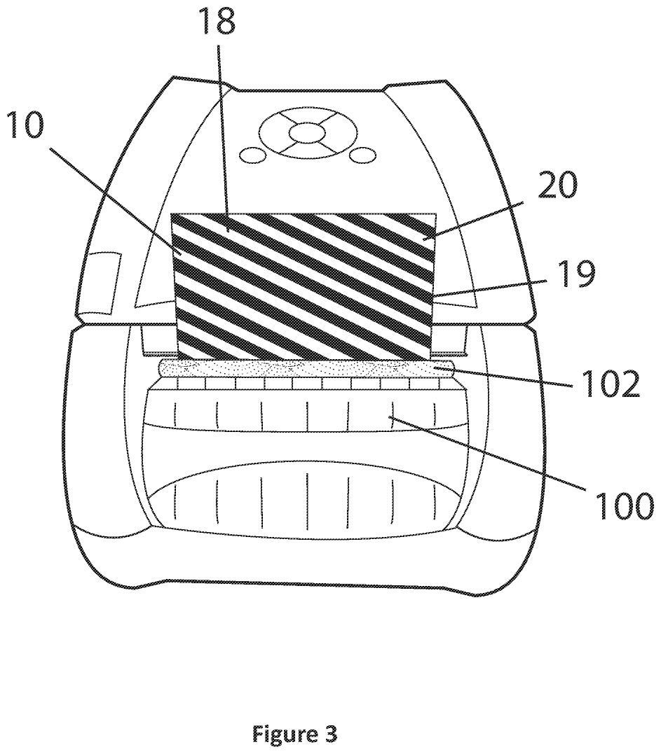

FIG. 3 shows linerless label 10 being processed through label printer 100, which in this case is a Zebra™ model ZQ630. Second side 18 of linerless label 10, comprising alternating in adhesive stripes 19 and adhesive voids 20, is visible in FIG. 3. As can be seen in FIG. 3, label printer 100 comprises platen roller 102, which is in contact with second side 18 of linerless label 10 as linerless label 10 is processed through label printer 100. A printhead (not shown) applies indicia to first side 12 of linerless label 10 as linerless label 10 is processed through label printer 100.

In at least one embodiment, because the alternating adhesive stripes 19 and adhesive voids 20 are the same width, platen roller 102 experiences 50% adhesive contact and 50% non-adhesive contact at all times that as linerless label 10 is processed through label printer 100. In at least one embodiment, the width of each adhesive stripe 19 is less than the exposed area of the platen roller 102 when the printer 100 is processing linerless label 10.

The alternating adhesive stripes 19 and adhesive voids 20 are arranged diagonally on second surface 18 of linerless label 10. The equal width of, and diagonal orientation of, alternating adhesive stripes 19 and adhesive voids 20 are selected so that as linerless label 10 is processed by printer 100, all surfaces of the platen roller 102 come into contact with at least the same amount of the linerless label with adhesive stripes 19 as the amount of the linerless label with adhesive voids 20, each time that contact alternates from adhesive stripe to adhesive void. Neither a vertical nor a horizontal arrangement of the alternating adhesive stripes 19 and adhesive voids 20 will accomplish this feature of the present disclosure.

In at least one embodiment, the angle formed by edge 14 and adhesive stripes 19 and adhesive voids 20 is about 30 degrees. In at least one embodiment, the angle formed by edge 14 and adhesive stripes 19 and adhesive voids 20 is about 45 degrees. In at least one embodiment, the angle formed by edge 14 and adhesive stripes 19 and adhesive voids 20 is about 60 degrees.

The adhesive pattern according to the present disclosure is designed mathematically and geometrically to correspond to the engraved cylinders (not shown) that apply the adhesive. Engraved cylinders that are used to apply adhesive to linerless labels are designed to repeat an adhesive pattern on a specific interval measured in inches. By way of nonlimiting examples, such an engraved cylinder may have a 12 inch repeat, or a 13 inch repeat, or a 14 inch, or a 15 inch repeat, or a 16 inch repeat.

In at least one embodiment, the pattern of alternating adhesive stripes 19 and adhesive voids 20 comprises a pattern of alternating 0.15 inch adhesive stripes 19 and 0.15 inch adhesive voids 20 at a 30 degree angle. This pattern is achieved by printing the adhesive stripes 19 with an engraved cylinder that prints at a 15 inch repeat. In other embodiments, the width of the adhesive stripes and adhesive voids may be larger than 0.15 inch or smaller than 0.15 inch. For example, if the engraved cylinder prints at a 16 inch repeat, there will be a pattern of alternating 0.16 inch adhesive stripes 19 and 0.16 inch adhesive voids 20. If the engraved cylinder prints at a 14 inch repeat, there will be a pattern of alternating 0.14 inch adhesive stripes 19 and 0.14 inch adhesive voids 20. If the engraved cylinder prints at a 13 inch repeat, there will be a pattern of alternating 0.13 inch adhesive stripes 19 and 0.13 inch adhesive voids 20. If the engraved cylinder prints at a 12 inch repeat, there will be a pattern of alternating 0.12 inch adhesive stripes 19 and 0.12 inch adhesive voids 20.

In at least one embodiment of the present disclosure, pattern of alternating adhesive stripes 19 and adhesive voids 20 is seamless, meaning that is no instance across the pattern where an adhesive stripe 19 becomes discontinuous. For example, as shown in FIG. 2, the top of each adhesive stripe 19 registers perfectly with the bottom of an adhesive stripe 19 when they wrap around the cylinder, and the result is that there is no beginning or end to the printed adhesive stripe 19, other than at the edge of the label. Due to the spacing, angle, and size of the stripes, this pattern provides a seamless pattern of alternating adhesive stripes 19 and adhesive voids 20 of substantially identical widths when printed with a cylinder on a repeat divisible by 1 inch.

In an exemplary embodiment of the present disclosure, the target width of each adhesive stripe 19 and adhesive void 20 is 0.125 inch. However, variation in the printing process can yield slightly wider adhesive stripes 19, and slightly narrower adhesive voids 20. The width of the printed adhesive stripe 19 will gain or widen to slightly more than the specified width, due to the amount of pressure applied by the engraved cylinder as it applies the adhesive. That gain bleeds into the adhesive void 20, so the intended width of the adhesive void 20 is correspondingly reduced. In an exemplary case, the result may be a 0.140 inch adhesive stripe 19 and a 0.110 inch adhesive void 20. Nevertheless, each adhesive stripe 19 and its adjacent adhesive void 20 remain spaced 0.125 inch center to center. Two consecutive adhesive stripes 19 remain 0.25 inch apart center to center, and two consecutive adhesive voids 20 also remain 0.25 inch apart center to center. Similarly, the sum of one adhesive stripe 19 and one adhesive void 20 remains 0.25 inch regardless of the gain. There are four adhesive stripes 19 and four adhesive voids 20 per inch in such an embodiment.

While this disclosure has been described as having preferred designs, the apparatus and methods according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

We claim:

1. A linerless label comprising:
a label material, said label material comprising a first side and an opposing second side, said first side and said second side being bounded by a leading edge, a trailing edge, a first side edge, and a second side edge; and
an adhesive on said second side of said label material, said adhesive configured in a plurality of parallel adhesive stripes oriented in a manner that is neither parallel to nor perpendicular to any of said leading edge, said trailing edge, said first side edge, or said second side edge, wherein all of said adhesive stripes are of substantially equal width, and where each said adhesive stripe is spaced apart from its neighboring adhesive stripe by an adhesive void that is of a substantially equal width to said adhesive stripes.

2. The linerless label of claim 1, wherein an angle formed by said first side edge and said adhesive stripes is between about 20 degrees and 45 degrees.

3. The linerless label of claim 2, wherein said angle formed by said first side edge and said adhesive stripes is between about 30 degrees and 40 degrees.

4. The linerless label of claim 3, wherein said angle formed by said first side edge and said adhesive stripes is between about 35 degrees and 40 degrees.

5. The linerless label of claim 2, wherein said angle formed by said first side edge and said adhesive stripes is about 30 degrees.

6. The linerless label of claim 1, wherein a combined width of one said adhesive stripe and one said adjacent adhesive void is about 0.25 inches.

7. The linerless label of claim 1, wherein each said adhesive stripe is about 0.125 inches wide and each said adhesive void is about 0.125 inches wide.

8. A linerless label comprising:
a label material, said label material comprising a first side and an opposing second side, said first side and said second side being bounded by a leading edge, a trailing edge, a first side edge, and a second side edge; and
an adhesive on said second side of said label material, said adhesive configured in a plurality of parallel adhesive stripes oriented in a manner that is neither parallel to nor perpendicular to any of said leading edge, said trailing edge, said first side edge, or said second side edge, wherein all of said adhesive stripes are of substantially equal width, and where each said adhesive stripe is spaced apart from its neighboring adhesive stripe by an adhesive void, wherein all of said adhesive voids are of substantially equal width.

9. The linerless label of claim 8, wherein an angle formed by said first side edge and said adhesive stripes is between about 20 degrees and 45 degrees.

10. The linerless label of claim 9, wherein said angle formed by said first side edge and said adhesive stripes is between about 30 degrees and 40 degrees.

11. The linerless label of claim 10, wherein said angle formed by said first side edge and said adhesive stripes is between about 35 degrees and 40 degrees.

12. The linerless label of claim 9, wherein said angle formed by said first side edge and said adhesive stripes is about 30 degrees.

13. The linerless label of claim 8, wherein each said adhesive stripe is about 0.125 inches wide and each said adhesive void is about 0.125 inches wide.

14. The linerless label of claim 8, wherein each said adhesive stripe is between about 0.125 inches wide and 0.15 inches wide and each said adhesive void is between about 0.1 inches wide and 0.125 inches wide.

15. The linerless label of claim 14, wherein a combined width of one said adhesive stripe and one said adjacent adhesive void is about 0.25 inches.
